(19) United States
(12) Patent Application Publication
(10) Pub. No.: US 2016/0373840 A1
(43) Pub. Date: Dec. 22, 2016

(54) ANTENNA BATTERY ASSEMBLY

(71) Applicant: Geospace Technologies Corporation, Houston, TX (US)

(72) Inventor: Timothy D. Becker, Cypress, TX (US)

(73) Assignee: Geospace Technologies Corporation, Houston, TX (US)

(21) Appl. No.: 14/741,123

(22) Filed: Jun. 16, 2015

(51) Int. Cl. H04Q 9/00

(52) U.S. Cl. CPC H04Q 9/00; H04Q 2209/60; H04Q 2209/88

(57) ABSTRACT

An antenna/battery pack suitable for powering an automatic meter reading system (“AMR”) and emitting a radio frequency signal received from a transmitter. The antenna/battery pack may be connected to a single-unit register/AMR device using a coaxial cable. This cable may connect to an electronic interconnect to allow for the replacement of the antenna/battery pack without the need to splice any wires. The antenna/battery pack may be easily replaceable such that a hermetically sealed single-unit register/AMR may be used for an extended period of time while the antenna/battery pack may be replaced more frequently.

### BACKGROUND OF THE INVENTION

### (1) Field Of the Invention

This invention relates generally to automatic meter reading units used to measure residential and commercial water usage.

### (2) Description of Prior Art

The reading of residential and commercial water usage via water meters has been, until recent years, accomplished primarily with human meter readers that came on-site to the premises and manually documented the readings.

Today there are millions of automatic meter reading (“AMR”) systems deployed throughout the world that use varying methods and degrees of automation to accomplish more efficient water meter reading. In the course of time, it is presumed these automated methods will offset the equipment investment with savings. In the electric utility industry this is very apparent, but continuing technical challenges can create a greater lag in the water utility industry. Most notably is powering the AMR units since they are often hermetically sealed and isolated from outside sources of power. The life of a typical AMR unit is dependent primarily upon the life of a battery.

Most of these AMR systems consist of two modules, a register and a separate transmitter/antenna/battery module. FIG. 1 depicts a common prior art AMR system configuration. The AMR system typically includes an antenna/transmitter/battery module 202. The system includes an electronic interconnect 204 and a register 200. The register 200 is in-line with the water pipe and measures the usage of water. Usually the register 200 will have an analog dial for manual readings as well as an electronic output signal available for an external device. In the configuration shown in FIG. 1, the external device is the AMR transmitter component of the antenna/transmitter/battery module 202. The transmitter typically provides a radio frequency (“RF”) signal to the antenna which radiates that signal so that it can be picked up remotely. The RF signal may be picked up in a number of ways. Some devices require a drive-by vehicle for the meter reading to be collected, while others can be relayed all the way to the utility office with no drive-by vehicle needed. There are currently two frequency bands allocated for this purpose near 900 MHz and 470 MHz.

As mentioned, there is one primary configuration of AMR water meter systems; a register 200 and a transmitter/antenna/battery module 202 of the AMR system. These are typically connected by a cable. The register 200 and rest of the AMR system may be permanently connected by a cable or may use an interconnect. The use of an interconnect 204 facilitates replacing components of the AMR system without splicing the cable or replacing the register 200 as well. The configuration with the interconnect 204 is the most costly but also the most flexible. Flexibility means that if a battery dies or other internal failure occurs, the AMR device can easily be replaced by disconnecting and replacing it.

The register 200 is in-line with a water pipe and measures the flow of water through that pipe. Because of the logistical need to bury most water pipes, the register 200 and other AMR components are often installed in cast iron, plastid, or concrete boxes slightly below ground level. These boxes are commonly called pit boxes 110 in the water utility industry. The environment within a pit box 110 may be quite harsh. The temperature typically fluctuates with the outdoor temperature through the blazing heat of summer and the freezing cold of winter. Additionally, the pit box 110 may be wet or may flood as a result of rain or snow. In order to protect the register 200 and other AMR components 202 from these conditions, the register and AMR component housings are often hermetically sealed.

Cost is a major factor when designing AMR systems. Combining the register and the other AMR components into a single unit would be a major breakthrough. There are two significant hurdles to this end:
1) Long term isolated power; and
2) Radio frequency propagation from below the surface of the ground and potentially under water.

These problems have been partially addressed in the prior art by placing the antenna element at or above ground level as in U.S. Pat. No. 6,177,883. Additionally, replaceable batteries are known in the prior art as discussed in U.S. Pat. No. 6,111,519.

### (3) Identification of Objects of the Invention.

An object of the invention is to create easily replaceable AMR batteries with an external antenna so as to increase the ease of replacing batteries for the system.

### SUMMARY OF THE INVENTION

An external antenna/battery pack is provided which is used in combination with a single-unit register/AMR device. The single-unit register/AMR device (usually provided beneath the system) contains all of the components necessary to measure water usage through a pipe and convert that information into an electronic signal that may be sent to an external antenna. The external antenna/battery pack is connected to the underground register/AMR device via a single connecter which may be a coaxial cable. This coaxial cable sends direct current electrical power from the battery pack to the AMR device and sends the radio frequency signal to the antenna for transmission to a distant station.

### BRIEF DESCRIPTION OF THE DRAWINGS

FIG. 1 is a plan view of a prior art automatic meter reader system containing a register 200 and an antenna/transmitter/battery module 202.

FIG. 2 is a view of a preferred embodiment of the invention showing a below ground single-unit register/AMR device 300 with a transmitter 303 connected to an external antenna/battery pack 315.

FIG. 3 illustrates an alternative embodiment of an antenna/battery pack 500 with a coaxial cable connector 520.

FIG. 4 illustrates a low-profile horizontally arranged embodiment of an antenna/battery pack 600 in which the battery pack 610 is mounted underneath the antenna element 605 and a protective case 625 encloses the antenna/battery pack 600.

### DESCRIPTION OF THE INVENTION

The following reference numbers are used to designate elements of the invention:
110—Utility Pit Box
115—Pit Box Lid
200—Prior Art Register
202—Prior Art Automatic Meter Reader Antenna/Transmitter/Battery Module
204—Prior Art Interconnect
300—Single Unit Register/AMR
302—Register
303—Transmitter
310—Interconnect
315—Antenna/Battery Pack
320—Antenna/Battery Pack Coaxial Cable
325—Water Pipe
405—Antenna Element
410—Battery Pack
415—Battery
500—Antenna/Battery Pack
505—Antenna Element
510—Battery Pack
515—Battery
520—Coaxial Cable Connector
600—Antenna/Battery Pack
605—Antenna Element
610—Battery Pack
615—Battery
620—Coaxial Cable
625—Protective Case

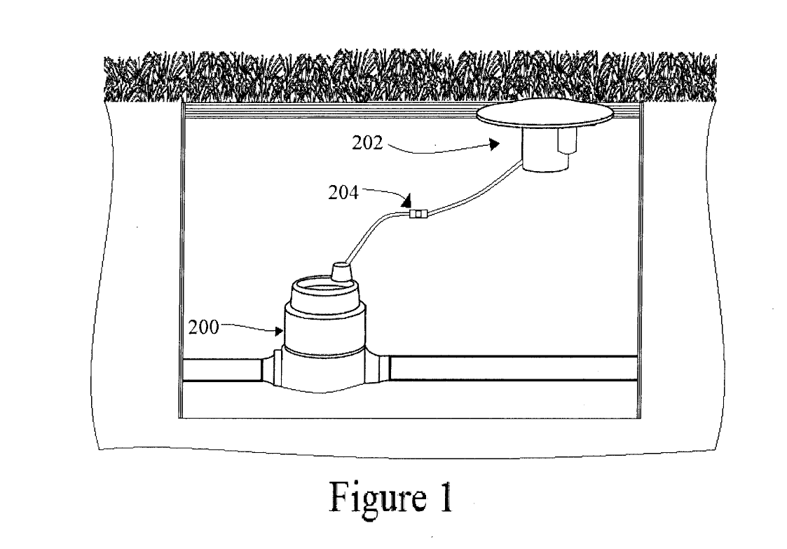

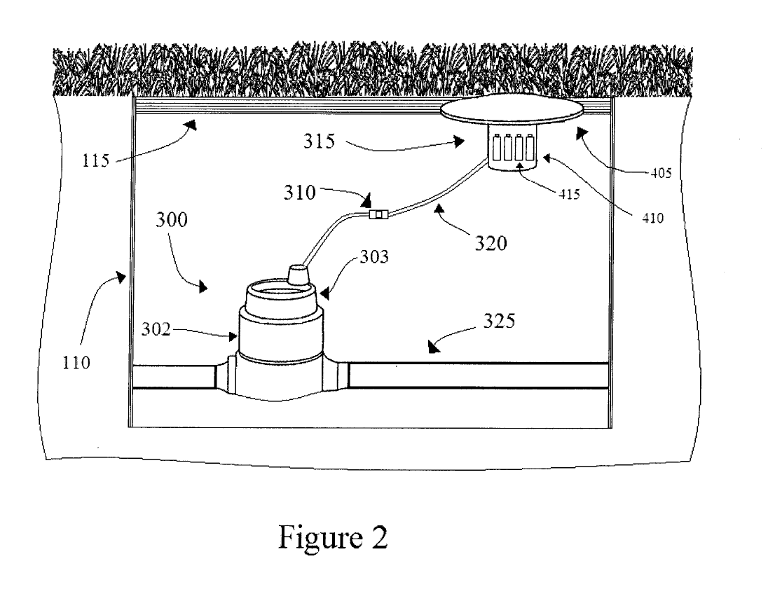

According to the invention as illustrated in FIG. 2, an antenna/battery pack 315 may be connected to a below ground single-unit register/AMR device 300 using a single coaxial cable 320. The amount of water flowing through a pipe 325 to a building is measured using a register 302. The water use information gathered by the register 302 is converted into an electronic signal by the electronics package of an automatic meter reader system (AMR). Traditionally, the AMR then transfers the electronic signal to an electronics package containing a transmitter, antenna, and power source. A transmitter 303 is positioned with the register 302 rather than with the antenna 405 as provided in the prior art arrangement of FIG. 1. The register 302 and transmitter 303 can be placed in a pit box 110 beneath the surface of the ground. This separation allows the transmitter 303 and associated electronics package to be hermetically sealed into a single-unit register/AMR 300 so that the electronics package and transmitter 303 are protected from the environmental conditions. This leaves only the antenna/battery pack 315 exposed to the external environment of the pit box 110. This arrangement facilitates the development of a lower cost single-unit register/AMR 300.

The external (i.e. separated from the transmitter) antenna element 405 has the added benefit of allowing greater radio frequency transmission. By placing the antenna 405 at or above ground level, the radio frequency signal is able to travel a greater distance compared to an antenna placed in the underground pit box 110 with the register 302 of the prior art arrangement of FIG. 1. The antenna/battery pack 315 may be connected to the register/AMR 300 using a single coaxial cable 320. The connection between the antenna/battery pack 315 and register/AMR 300 is designed to allow the antenna/battery pack 315 to be easily replaceable and must also be designed to endure the environmental conditions of an underground pit box 110. The external antenna/battery pack 315 is connected to the sealed register/AMR device 300 using an electrical connector assembly such as that described in U.S. Pat. No. 7,033,193 or by any other suitable electrical connector.

FIG. 2 illustrates a preferred embodiment of the antenna/battery pack 315 connected to a single-unit register/AMR 300. In this embodiment, the antenna/battery pack 315 is connected to a coaxial cable 320. The register/AMR 300 is connected to a similar coaxial cable. The two coaxial cables are connected to each other by an interconnect 310. This arrangement allows the coaxial cable 320 to be disconnected from the interconnect 310. Once the cable 320 is disconnected, the antenna/battery pack 315 may be removed and replaced without removing the single-unit register/AMR 300. FIG. 2 also shows a detailed view of the antenna/battery pack 315. In this embodiment, the battery pack 410 is vertically arranged under the antenna 405 and houses two or more batteries 415.

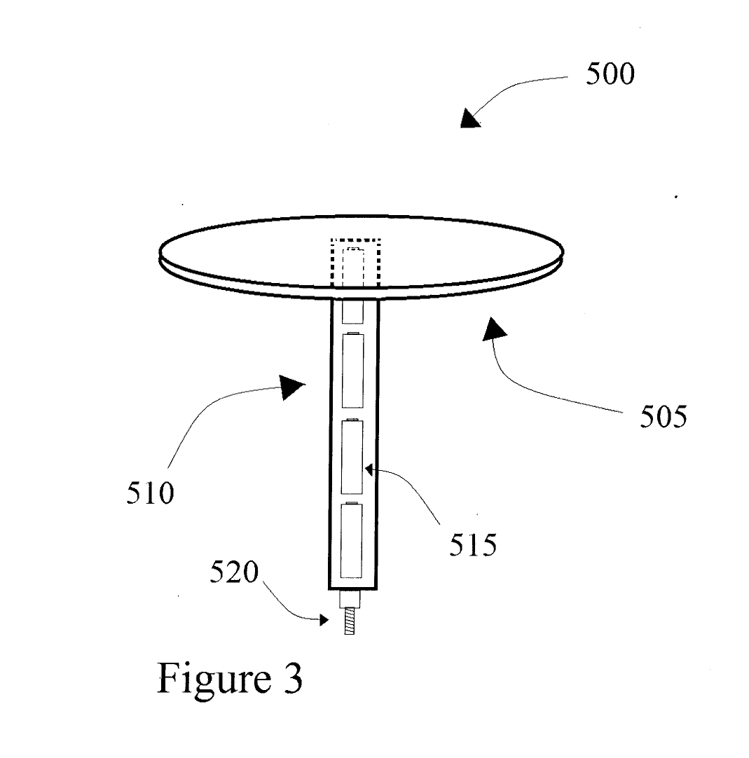

FIG. 3 depicts an alternative arrangement of an antenna/battery pack 500. In this embodiment, the battery pack 510 is arranged and designed to extend below the antenna 505 in a vertical, narrow design. This embodiment does not have an integrated coaxial cable. Instead, this embodiment comprises a coaxial cable connector 520 which requires a separate coaxial cable to be used to connect the connector 520 to an interconnect 310 or a single-unit register/AMR device 300.

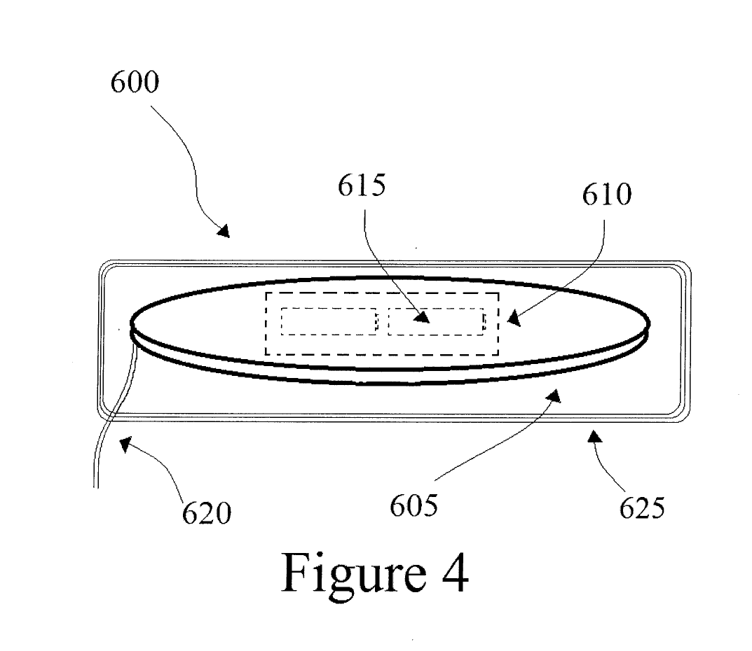

FIG. 4 illustrates a horizontal arrangement of the antenna/battery pack 600. This arrangement may be useful for installing onto pit box lids 115 or integrating into the lids 115.

This arrangement places the batteries 615 and battery pack 610 horizontally underneath the antenna element 605.

The claimed subject matter is not to be limited in scope by the specific embodiments described herein. This application refers frequently to battery packs but it is clear that other sources of power (e.g., solar panels) would be appropriate substitutes. Indeed, various modifications of the invention in addition to those described herein will become apparent to those skilled in the art from the foregoing description. Such modifications are intended to fall within the scope of the appended claims.

What is claimed is:

1. An arrangement of an automatic meter reading system associated with a water utility meter, the arrangement comprising:
a register (302) arranged and designed to measure the flow of water through a pipe (325);
a transmitter (303) positioned with and connected to the register (302);
an antenna element (405) remotely positioned from the transmitter (303);
a coaxial cable (320) operably connected to the antenna element (405) and to the transmitter (303), said coaxial cable (320) arranged and designed to communicate a radio frequency signal received from the transmitter (303) to the antenna element (405);
a battery pack (410) positioned with the antenna element (405); and,
an interconnect (310) arranged and designed to allow the coaxial cable (320) to be disconnected and reconnected, thus allowing the battery pack (410) and antenna element (405) to be removed and replaced without removing the register (302) or transmitter (303).

2. The arrangement of claim 1, wherein the battery pack (410) is operably connected to the coaxial cable (320); and,
said coaxial cable (320) is arranged and designed to transfer power from the battery pack (410) to the transmitter (303).

3. The arrangement of claim 1, wherein the antenna element (405) is installed at or above ground level.

4. The arrangement of claim 1, wherein the antenna element (405) is incorporated into a utility pit box lid (115).

5. The arrangement of claim 2, further comprising a protective case (625);
the protective case (625) being arranged and designed to protect the antenna element (405) and battery pack (410) from the external environment.

6. An antenna/power source (315) associated with an automatic meter reading system, the antenna/power source (315) comprising:
an antenna element (405) operably connected to a coaxial cable (320); and,
a power source operably connected to said coaxial cable (320), wherein the coaxial cable (320) is arranged and designed to communicate a signal received from a remotely positioned transmitter (303) to the antenna element (405) and to transfer power from the power source to the remotely positioned transmitter (303).

7. The device of claim 6, further comprising an protective case (625) arranged and designed to protect the antenna element (405) and power source from the external environment.

8. The device of claim 7, wherein the case (625) is hermetically sealed.

9. The device of claim 7, wherein the case (625) is arranged and designed to attach to the lid (115) of a utility pit box (110).

10. The device of claim 6, wherein the antenna/power source (315) is arranged and designed to be integrated into a pit box lid (115).

11. The device of claim 6, wherein the antenna element (405) is a loop antenna.

12. The device of claim 6, wherein the power source is a battery pack (410).

13. An antenna/power source (315) associated with an automatic meter reading system, the antenna/power source (315) comprising:
an antenna element (405) operably connected to a coaxial cable connector (520); and,
a power source operably connected to said coaxial cable connector (520); and,
a coaxial cable (320) operably connected to the coaxial cable connector (520) and to a remotely located transmitter (303), wherein the coaxial cable is arranged and designed to communicate a radio frequency signal received from the remotely located transmitter (303) to the coaxial cable connecter (520),
the coaxial cable connector (520) arranged and designed to communicate the radio frequency signal received from the coaxial cable (320) to the antenna element (405).

14. The device of claim 13, further comprising a protective housing (625) arranged and designed to protect the antenna element (405) and power source from the external environment.

15. The device of claim 14, wherein the protective housing (625) is arranged and designed to attach to a pit box lid (115).

16. The device of claim 13, wherein the antenna/power source (315) is integrated into a pit box lid (115).

17. The device of claim 13, wherein the power source is a battery pack (410).
